(19) United States
(12) Patent Application Publication
(10) Pub. No.: US 2026/0160996 A1
(43) Pub. Date: Jun. 11, 2026

(54) DIOPTER ADJUSTMENT METHOD FOR AUGMENTED-REALITY DISPLAY APPARATUS, AND AUGMENTED-REALITY DISPLAY APPARATUS

(71) Applicant: SHENZHEN HUYNEW TECHNOLOGY CO., LTD., Shenzhen, Guangdong (CN)

(72) Inventors: Cong FENG, Shenzhen, Guangdong (CN); Xu WANG, Shenzhen, Guangdong (CN); Qijie QING, Shenzhen, Guangdong (CN); Weiwei ZHANG, Shenzhen, Guangdong (CN)

(73) Assignee: SHENZHEN HUYNEW TECHNOLOGY CO., LTD., Shenzhen, Guangdong (CN)

(21) Appl. No.: 19/127,114

(22) PCT Filed: Apr. 17, 2023
(86) PCT No.: PCT/CN2023/088646

§ 371 Date: May 4, 2025

(30) Foreign Application Priority Data
Nov. 16, 2022 (CN) 202211433125.4

(51) Int. Cl. G02B 27/01; G02B 7/10

(52) U.S. Cl. CPC G02B 27/0101; G02B 7/10

(57) ABSTRACT

An augmented reality display device and a diopter adjustment method are provided. The augmented reality display device includes a display unit, a lens group and a light guide assembly. The lens group is arranged on an output light path of the display unit, and light from the display unit is transmitted through the lens group, incident on the light guide assembly, and propagated to an eyebox area through the light guide assembly. The method includes: controlling the display unit and the lens group to move along an optical axis to change a diopter between a first diopter value and a second diopter value; and controlling the display unit to move along the optical axis to change the diopter between the second diopter value and a third diopter value.

The present application claims the priority to Chinese Patent Application No. 202211433125.4, titled “DIOPTER ADJUSTMENT METHOD FOR AUGMENTED-REALITY DISPLAY APPARATUS, AND AUGMENTED-REALITY DISPLAY APPARATUS”, filed with the China National Intellectual Property Administration on Nov. 16, 2022, the entire content of which is incorporated herein by reference.

### FIELD

The present application relates to the technical field of optical systems, and in particular to a diopter adjustment method for augmented reality display device. The present application further relates to an augmented reality display device.

### BACKGROUND

Augmented Reality (AR) technology is an innovative technology that seamlessly integrates information from both the real and virtual worlds. It utilizes computer technology and other scientific methods to simulate and superimpose physical information (visual information, sounds, tastes, tactile sensations, etc.) that is otherwise difficult to encounter within the confines of time and space in the real world. With AR technology, the virtual information can be applied to the real world and perceived by human senses, creating sensory experiences that transcend reality. Specifically, it superimposes the real environment and virtual objects into the same view or space in real time.

In order to meet the viewing needs of users with vision challenges, such as individuals with myopia, the diopter of existing augmented reality display devices can be adjusted based on different degrees of myopia. In the conventional technology, there are two diopter adjustment methods for the augmented reality display devices. One method involves moving a display unit to change a distance between the display unit and a lens group. During actual operations, however, this adjustment method may result in an insufficient range of an eyebox in a horizontal direction, leading to blurred image edges during the adjustment process. The other method involves simultaneously moving the display unit and the lens group to change a distance from the display unit and the lens group to a light guide assembly. During actual operations, this adjustment method may cause an insufficient range of the eyebox in a vertical direction, resulting in darkened or even incomplete image edges during the adjustment process.

### SUMMARY

An object of the present application is to provide a diopter adjustment method for an augmented reality display device, which can enlarge the eyebox range within the same diopter adjustment range, so as to prevent a blurred or incomplete edge of an image caused by insufficient eyebox range. An augmented reality display device is further provided according to the present application.

In order to achieve the above objects, the following technical solutions are provided according to the present application.

A diopter adjustment method for an augmented reality display device is provided. The augmented reality display device includes a display unit, a lens group and a light guide assembly. The lens group is arranged on an output light path of the display unit, and light from the display unit is transmitted through the lens group, incident on the light guide assembly, and propagated to an eyebox area through the light guide assembly.

The method includes the following steps:
controlling the display unit and the lens group to move along an optical axis to change a diopter of the augmented reality display device between a first diopter value and a second diopter value, where a relative position between the display unit and the lens group remains unchanged; and
controlling the display unit to move along the optical axis to change the diopter of the augmented reality display device between the second diopter value and a third diopter value, where a position of the lens group remains unchanged, and the second diopter value is a value between the first diopter value and the third diopter value.

Preferably, the step of controlling the display unit and the lens group to move along the optical axis to change the diopter of the augmented reality display device between the first diopter value and the second diopter value includes:
controlling the display unit and the lens group to move towards the light guide assembly along the optical axis to change a diopter of the augmented reality display device towards the second diopter value; and
controlling the display unit and the lens group to move away from the light guide assembly along the optical axis to change the diopter of the augmented reality display device towards the first diopter value.

Preferably, the step of controlling the display unit to move along the optical axis to change the diopter of the augmented reality display device between the second diopter value and the third diopter value includes:
controlling the display unit to move towards the lens group along the optical axis to change the diopter of the augmented reality display device towards the third diopter value; and
controlling the display unit to move away from the lens group along the optical axis to change the diopter of the augmented reality display device towards the second diopter value.

Preferably, the following conditions are satisfied: d1 ranges from 0.1 mm to 2 mm, and d2 ranges from 0.5 mm to 3.5 mm, where

d2 represents a movement distance of the display unit and the lens group along the optical axis when the diopter of the augmented reality display device is changed between the first diopter value and the second diopter value, and d1 represents a movement distance of the display unit along the optical axis when the diopter of the augmented reality display device is changed between the second diopter value and the third diopter value.

An augmented reality display device includes a display unit, a lens group, a light guide assembly and an adjustment assembly. The lens group is disposed on an output light path of the display unit, and light from the display unit is transmitted through the lens group, incident on the light guide assembly, and propagated to an eyebox area through the light guide assembly.

The adjustment assembly is connected to the display unit and the lens group, and is configured to control the display unit and the lens group independently to move along an optical axis, so as to perform the above diopter adjustment method for the augmented reality display device.

Preferably, the light guide assembly includes a first optical element and a second optical element. Light from the display unit is transmitted through the lens group and incident on the first optical element, and the first optical element is configured to reflect light from the lens group to the second optical element and transmit light from the second optical element. The second optical element is configured to reflect light from the first optical element back to the first optical element, and a reflecting surface of the second optical element is a curved surface.

The following conditions are further satisfied. A distance D1 between the display unit and the lens group ranges from 0.1 mm to 2.5 mm, a distance D2 between the lens group and the first optical element ranges from 7 mm to 11.5 mm, and a distance D3 between the first optical element and the second optical element ranges from 6.5 mm to 11 mm.

Preferably, a field-of-view of the augmented reality display device ranges from 35° to 50°.

Preferably, a range of a variation of the field-of-view of the augmented reality display device satisfies ΔFOV<6°, where ΔFOV represents the variation of the field-of-view.

Preferably, when the diopter of the augmented reality display device is changed between the first diopter value and the second diopter value, a combined focal length of the lens group and the light guide assembly ranges from 22 mm to 17 mm.

When the diopter of the augmented reality display device is changed between the second diopter value and the third diopter value, the combined focal length of the lens group and the light guide assembly remains unchanged.

Preferably, an exit pupil distance of the augmented reality display device is greater than 12 mm, and an exit pupil size of the augmented reality display device is 10*6 mm or above.

According to the above technical solutions, a diopter adjustment method for an augmented reality display device is provided in the present application. The augmented reality display device includes the display unit, the lens group and the light guide assembly. The lens group is arranged on the output light path of the display unit, and light from the display unit is transmitted through the lens group, incident on the light guide assembly, and propagated to the eyebox area through the light guide assembly. The method includes the following steps: controlling the display unit and the lens group to move along the optical axis to change the diopter of the augmented reality display device between the first diopter value and the second diopter value with the relative position of the display unit and the lens group remaining unchanged, and controlling the display unit to move along the optical axis to change the diopter of the augmented reality display device between the second diopter value and the third diopter value, where the second diopter value is a value between the first diopter value and the third diopter value.

According to the diopter adjustment method for the augmented reality display device provided in the present application, the diopter adjustment range of the augmented reality display device is divided into multiple intervals. In different intervals, the diopter is adjusted by controlling the display unit and the lens group to move synchronously, or by controlling the display unit to move, so that the diopter of the augmented reality display device is adjusted by different adjustment methods in combination. Compared with the existing adjustment methods of only adjusting the display unit or adjusting both the display unit and the lens group synchronously, within the same diopter adjustment range, the diopter adjustment method in the present application can avoid blurred or incomplete image edges caused by insufficient eyebox range.

The augmented reality display device according to the present application can also achieve the above beneficial effects.

### BRIEF DESCRIPTION OF THE DRAWINGS

In order to more clearly illustrate the technical solutions in the embodiments of the present application or in the conventional technology, the accompanying drawings referred to in the description of the embodiments or the conventional technology will be briefly described below. Obviously, the accompanying drawings in the following description merely show some embodiments of the present application. Based on these drawings, other drawings may be obtained by those skilled in the art without any creative effort.

FIG. 1 is a schematic view of an augmented reality display device employing a diopter adjustment method for an augmented reality display device according to an embodiment of the present application;

FIG. 2 is a flowchart of a diopter adjustment method for an augmented reality display device according to an embodiment of the present application;

FIG. 3 is a schematic view of an augmented reality display device according to an embodiment of the present application;

FIG. 4 is a schematic view of an augmented reality display device according to another embodiment of the present application;

FIG. 5 is an optical path diagram of an existing augmented reality display device where light is blocked;

FIG. 6 is a modulation transfer function (MTF) chart of an edge of an eyebox of an augmented reality display device according to an embodiment of the present application; and

FIG. 7 is a modulation transfer function (MTF) chart of an edge of an eyebox of an augmented reality display device according to another embodiment of the present application.

Reference numerals in the accompanying drawings are explained as follows:

| | |
|---|---|
| 100. eyebox area; | 101. display unit; |
| 102. lens group; | 103. light guide assembly; |
| 104. adjustment assembly; | 105. first optical element; |
| 106. second optical element. | |

### DETAILED DESCRIPTION OF THE EMBODIMENTS

In order to enable those skilled in the art to better understand the technical solutions in the present application, the technical solutions in the embodiments of the present application will be clearly and completely described below with reference to the accompanying drawings in the embodiments of the present application. Obviously, the described embodiments are only some rather than all of the embodiments of the present application. Based on the embodiments of the present application, all other embodiments obtained by those skilled in the art without creative efforts fall within the protection scope of the present application.

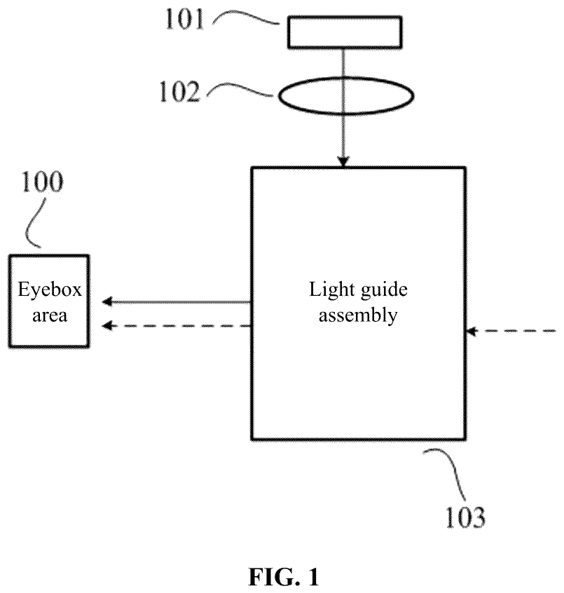

In this embodiment, a diopter adjustment method for an augmented reality display device is provided, which is applied to the augmented reality display device. Referring to FIG. 1, FIG. 1 is a schematic view of an augmented reality display device employing the diopter adjustment method for the augmented reality display device according to an embodiment of the present application. As shown in FIG. 1, the augmented reality display device includes a display unit 101, a lens group 102 and a light guide assembly 103. The lens group 102 is arranged on an output light path of the display unit 101, and light from the display unit 101 is transmitted through the lens group 102, incident on the light guide assembly 103, and propagated to an eyebox area 100 through the light guide assembly 103.

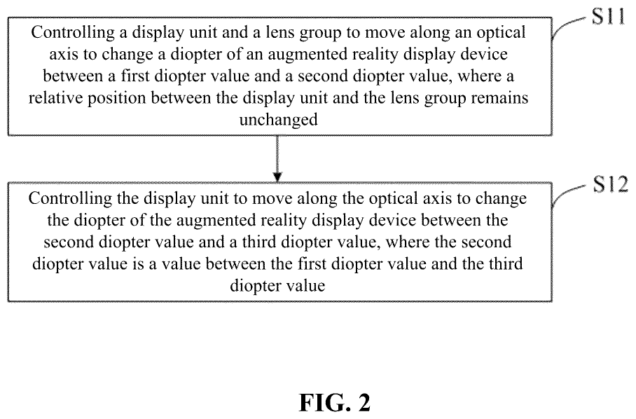

Referring to FIG. 2, FIG. 2 is a flowchart of a diopter adjustment method for an augmented reality display device according to an embodiment. As shown in FIG. 2, the method includes the following steps.

In step S11, the display unit 101 and the lens group 102 are controlled to move along an optical axis, such that a diopter of the augmented reality display device is changed between a first diopter value and a second diopter value, where a relative position of the display unit 101 and the lens group 102 remains unchanged.

In step S12, the display unit 101 is controlled to move along the optical axis, such that the diopter of the augmented reality display device is changed between the second diopter value and a third diopter value, where a position of the lens group 102 remains unchanged, and the second diopter value is a value between the first diopter value and the third diopter value.

The light from the display unit 101 is transmitted through the lens group 102, incident on the light guide assembly 103, and propagated to the eyebox area 100 through the light guide assembly 103. The light enters eyes of an observer, and the observer can see image information of the display unit 101. The diopter of the augmented reality display device is used to characterize a distance between the virtual image and the observer, that is, −1/VID, where VID (virtual image distance) is a virtual image distance which is measured in the unit of meter.

In the augmented reality display device, the display unit 101 and the lens group 102 are moved along the optical axis to change a distance from the display unit 101 and the lens group 102 to the light guide assembly 103, and in this way, the diopter of the augmented reality display device can be changed. The display unit 101 is moved along the optical axis, during which process the position of the lens group 102 remains unchanged, to change a distance between the display unit 101 and the lens group 102, and in this way, the diopter of the augmented reality display device can also be changed. Specifically, in the augmented reality display device, when the display unit 101 and the lens group 102 are moved along the optical axis, the diopter of the augmented reality display device is changed between the first diopter value and the second diopter value. When the display unit 101 is move along the optical axis, the diopter of the augmented reality display device is changed between the second diopter value and the third diopter value.

In the augmented reality display device, the diopter adjustment range is divided into multiple intervals. The diopter is adjusted within a diopter range between the first diopter value and the second diopter value by controlling the display unit 101 and the lens group 102 to move synchronously, and the diopter is adjusted within another diopter range between the second diopter value and the third diopter value by controlling the display unit 101 to move. The diopter adjustment method for the augmented reality display device according to this embodiment combines different adjustment methods to adjust the diopter of the augmented reality display device.

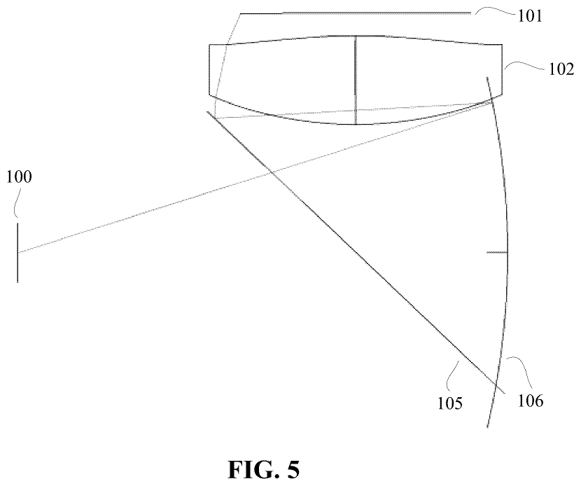

In the conventional technology, there are two diopter adjustment methods for augmented reality display devices. One method involves moving the display unit to change the distance between the display unit and the lens group, so as to adjust the diopter. The other method involves moving the display unit and the lens group synchronously. In the first method, in order to achieve a large diopter adjustment range, the distance between the display unit and the lens group is very large, which will degrade the quality of the image. In this case, it is unlikely to have a large eyebox range in the horizontal direction, and the observer will see blurred edges of the image at a proper distance. In the second method, in order to achieve a large diopter adjustment range, a movement distance of the display unit and the lens group will be large, which often cause the light to be blocked when the diopter is high. As shown in FIG. 5, FIG. 5 is an optical path diagram of an existing augmented reality display device where the light is blocked. That is, the lens group 102 blocks the image light, and as a result, the brightness in an upper region of the image is decreased, or the upper region of the image is even completely blocked, thereby reducing the range of the eyebox in the vertical direction and leading to an incomplete image.

According to the diopter adjustment method for the augmented reality display device in this embodiment, the diopter adjustment range is divided into multiple intervals. Within different intervals, the diopter is adjusted by controlling the display unit 101 and the lens group 102 to move synchronously, or by controlling the display unit 101 to move, so that the diopter of the augmented reality display device is adjusted by combining different adjustment methods. Compared with the first existing adjustment method, within the same diopter adjustment range, the diopter adjustment method according to the present application can prevent the distance between the display unit and the lens group from being too large, thereby avoiding the blurred image edge. Compared with the second existing adjustment method, within the same diopter adjustment range, the diopter adjustment method according to the present application can reduce the movement distances of the display unit and the lens group, thereby avoiding the problem of incomplete images due to the light being blocked.

The second diopter value is a value between the first diopter value and the third diopter value, that is, the second diopter value is between the first diopter value and the third diopter value. In this embodiment, the magnitude relationship between the first diopter value and the third diopter value is not limited. The first diopter value may be greater than the third diopter value, or the first diopter value may be less than the third diopter value. For example, in some embodiments, the first diopter value is an upper limit of the diopter of the augmented reality display device, and the third diopter value is a lower limit of the diopter of the augmented reality display device.

In some embodiments, the step S11 of controlling the display unit 101 and the lens group 102 to move along the optical axis to change the diopter of the augmented reality display device between the first diopter value and the second diopter value includes the following process:
controlling the display unit 101 and the lens group 102 to move towards the light guide assembly 103 along the optical axis to change the diopter of the augmented reality display device towards the second diopter value; and
controlling the display unit 101 and the lens group 102 to move away from the light guide assembly 103 along the optical axis to change the diopter of the augmented reality display device towards the first diopter value.

That is, in this augmented reality display device, when the display unit 101 and the lens group 102 are moved towards the light guide assembly 103 along the optical axis, the diopter of the augmented reality display device is changed towards the second diopter value. When the display unit 101 and the lens group 102 are moved away from the light guide assembly 103 along the optical axis, the diopter of the augmented reality display device is changed towards the first diopter value. In an example, a current diopter value and a target diopter value of the augmented reality display device are both between the first diopter value and the second diopter value, and the diopter values can be sorted based on their relative magnitude relationship as follows: the first diopter value, the current diopter value, the target diopter value and the second diopter value, where the target diopter value refers to a diopter value that is the target of the adjustment. In this case, the display unit 101 and the lens group 102 are moved towards the light guide assembly 103 along the optical axis, so that the diopter of the augmented reality display device is adjusted to the target diopter value.

In some embodiments, the step S12 of controlling the display unit 101 to move along the optical axis to change the diopter of the augmented reality display device between the second diopter value and the third diopter value includes the following processes:
controlling the display unit 101 to move towards the lens group 102 along the optical axis to change the diopter of the augmented reality display device towards the third diopter value; and
controlling the display unit 101 to move away from the lens group 102 along the optical axis to change the diopter of the augmented reality display device towards the second diopter value.

That is, in this augmented reality display device, when the display unit 101 is moved towards the lens group 102 along the optical axis, the diopter of the augmented reality display device is changed towards the third diopter value. When the display unit 101 is moved away from the lens group 102 along the optical axis, the diopter of the augmented reality display device is changed towards the second diopter value. In another example, a current diopter value and a target diopter value of the augmented reality display device are both between the second diopter value and the third diopter value, and the diopter values can be sorted based on their relative magnitude relationship as follows: the second diopter value, the target diopter value, the current diopter value and the third diopter value, where the target diopter value refers to a diopter value that is the target of the adjustment. In this case, the display unit 101 is moved away from the lens group 102 along the optical axis, so that the diopter of the augmented reality display device is adjusted from the current diopter value to the target diopter value.

In further another example, the current diopter value of the augmented reality display device is between the first diopter value and the second diopter value, and the target diopter value is between the second diopter value and the third diopter value. In this case, the display unit 101 and the lens group 102 are moved along the optical axis first, during which process the relative position between the display unit 101 and the lens group 102 remains unchanged, so that the diopter of the augmented reality display device reaches the second diopter value. Then the display unit 101 continues to be moved along the optical axis, during which process the position of the lens group 102 remains unchanged, so that the diopter of the augmented reality display device is adjusted to the target diopter value.

Similarly, in further another example, the current diopter value of the augmented reality display device is between the second diopter value and the third diopter value, and the target diopter value is between the first diopter value and the second diopter value. In this case, the display unit 101 is moved along the optical axis first, during which process the position of the lens group 102 remains unchanged, so that the diopter of the augmented reality display device reaches the second diopter value. Then the display unit 101 and the lens group 102 are moved along the optical axis, during which process the relative position between the display unit 101 and the lens group 102 remains unchanged, so that the diopter of the augmented reality display device is adjusted to the target diopter value.

In some embodiments, d1 and d2 satisfy the following conditions: d1 ranges from 0.1 mm to 2 mm, and d2 ranges from 0.5 mm to 3.5 mm, where
d2 represents a movement distance of the display unit 101 and the lens group 102 that move along the optical axis when the diopter of the augmented reality display device is changed between the first diopter value and the second diopter value, and d1 represents the movement distance of the display unit 101 that moves along the optical axis when the diopter of the augmented reality display device is changed between the second diopter value and the third diopter value.

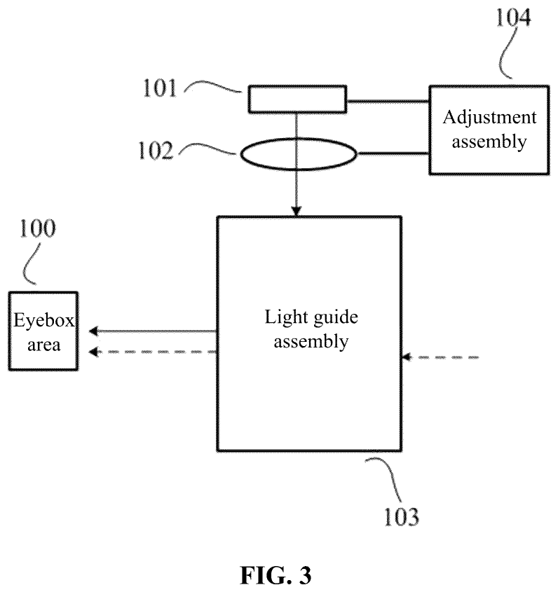

In this embodiment, an augmented reality display device is further provided. Referring to FIG. 3, FIG. 3 is a schematic view of an augmented reality display device according to an embodiment of the present application. As shown in FIG. 3, the augmented reality display device includes a display unit 101, a lens group 102, a light guide assembly 103 and an adjustment assembly 104. The lens group 102 is arranged on an output light path of the display unit 101, and light from the display unit 101 is transmitted through the lens group 102, incident on the light guide assembly 103, and propagated to an eyebox area 100 through the light guide assembly 103.

The adjustment assembly 104 is connected to the display unit 101 and the lens group 102, and is configured to independently control the display unit 101 and the lens group 102 to move along an optical axis, so as to perform the diopter adjustment method for the augmented reality display device according to any one of the above embodiments.

The light from the display unit 101 is transmitted through the lens group 102 and incident on the light guide assembly 103, so that the light from the display unit 101 is propagated to the eyebox area 100 through the light guide assembly 103 to enter the eyes of the observer, and in this way, the observer can see image information of the display unit 101.

In the augmented reality display device, the display unit 101 and the lens group 102 can be controlled by the adjustment assembly 104 to move along the optical axis, so as to change a distance from the display unit 101 and the lens group 102 to the light guide assembly 103, and in this way, the diopter of the augmented reality display device can be changed. The display unit 101 can be controlled by the adjustment assembly 104 to move along the optical axis while the position of the lens group 102 remains unchanged, causing a distance between the display unit 101 and the lens group 102 to be changed, and in this way, the diopter of the augmented reality display device can also be changed. Specifically, in the augmented reality display device, when the display unit 101 and the lens group 102 are moved along the optical axis, the diopter of the augmented reality display device can be changed between the first diopter value and the second diopter value. When the display unit 101 is moved along the optical axis, the diopter of the augmented reality display device can be changed between the second diopter value and the third diopter value.

In the augmented reality display device according to this embodiment, the diopter adjustment range is divided into multiple intervals. The diopter is adjusted within a diopter range between the first diopter value and the second diopter value by controlling the display unit 101 and the lens group 102 to move synchronously, and the diopter is adjusted within another diopter range between the second diopter value and the third diopter value by controlling the display unit 101 to move. The augmented reality display device according to this embodiment combines different adjustment methods to realize the adjustment to the diopter of the augmented reality display device.

In some embodiments, the light guide assembly 103 includes a first optical element and a second optical element. Light from the display unit 101 is transmitted through the lens group 102 and incident on the first optical element, which is configured to reflect light from the lens group 102 to the second optical element and transmit light from the second optical element. The second optical element is configured to reflect light from the first optical element back to the first optical element. Light from the second optical element is transmitted through the first optical element and incident on the eyebox area 100. Light from the real world is sequentially transmitted through the second optical element and the first optical element and incident on the eyebox area 100, so that the observer can see an effect that the formed virtual image is superimposed onto the real world.

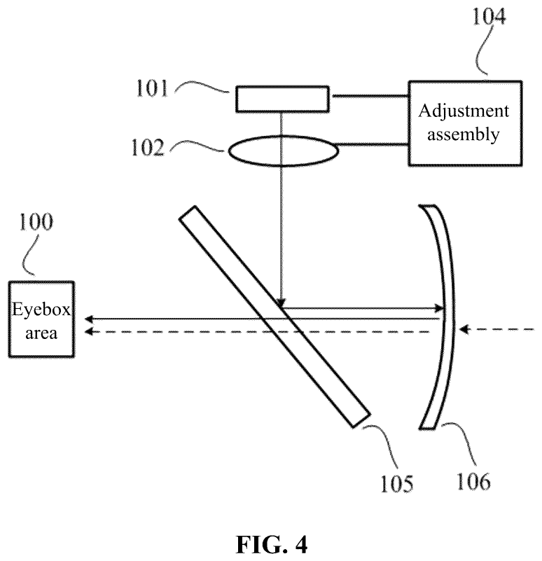

Preferably, a reflecting surface of the second optical element is a curved surface, so that the light from the display unit 101 can be deflected by the second optical element to some extent. Referring to FIG. 4, FIG. 4 is a schematic view of an augmented reality display device according to another embodiment. As shown in the drawings, the light from the display unit 101 is transmitted through the lens group 102 and incident on the first optical element 105. Then the light is reflected by the first optical element 105 to the second optical element 106 and reflected back to the first optical element 105 by the second optical element 106. The light is further transmitted through the first optical element 105 and reaches an eyebox area 100. In FIG. 1, FIG. 3 and FIG. 4, the solid lines with arrows indicate propagation directions of the light from the display unit 101, and the dashed lines with arrows indicate propagation directions of light from the external environment. The reflecting surface of the second optical element 106 is a concave surface, which can reflect the incident light in a convergent manner. The first optical element 105 may be a plane mirror, and the second optical element 106 may be a concave mirror.

Further, the augmented reality display device satisfies the following conditions. A distance D1 between the display unit 101 and the lens group 102 ranges from 0.1 mm to 2.5 mm, a distance D2 between the lens group 102 and the first optical element 105 ranges from 7 mm to 11.5 mm, and a distance D3 between the first optical element 105 and the second optical element 106 ranges from 6.5 mm to 11 mm. Preferably, the distance D3 between the first optical element 105 and the second optical element 106 ranges from 8 mm to 9 mm.

In some embodiments, a field-of-view (FOV) of the augmented reality display device ranges from 35° to 50°.

Further, in this embodiment, the first diopter value is OD and the third diopter value is −6D. As the diopter of the augmented reality display device decreases from OD, the field-of-view (FOV) decreases continuously. In a first adjustment distance, the field-of-view (FOV) fluctuates within a small range. In a second adjustment distance, the field-of-view (FOV) fluctuates within a large range, where ΔFOV<6°, and ΔFOV represents a variation of the field-of-view.

Further, in this embodiment, an exit pupil distance of the augmented reality display device is greater than 12 mm, and an exit pupil size is 10*6 mm or above. Compared with a diopter adjustment module with a single adjustment method, the display effect of this module is better.

A combined focal length of the lens group 102 and the light guide assembly 103 is changed with the diopter. In some embodiments, when the diopter of the augmented reality display device is changed between the first diopter value and the second diopter value, the combined focal length of the lens group 102 and the light guide assembly 103 varies between 22 mm and 17 mm. When the diopter of the augmented reality display device is changed between the second diopter value and the third diopter value, the combined focal length of the lens group 102 and the light guide assembly 103 remains unchanged.

The units in the following tables are millimeters. EFL-lens group represents a focal length of the lens group 102, and EFL-all represents the combined focal length of the lens group 102 and the light guide assembly 103.

| First | Distance D2 | Distance D1 | EFL- | |
|---|---|---|---|---|
| embodi- | between first optical | between display | lens | EFL- |
| ment | element and lens group | unit and lens group | group | all |
| 0D | 9.5 | 1.5 | 21.818\ | 20.168 |
| −3d | 7.7 | 1.5 | | 19.5 |
| −6d | 7.7 | 0.1 | | 19.5 |

where d2 = 1.8 mm, 0D-FOV: 44°, −6D-FOV: 40°, ΔFOV = 4°, D3 = 9 mm, and an eyebox size is 13 mm*8.2 mm.

| | Distance D2 | Distance D1 | EFL- | |
|---|---|---|---|---|
| Second | between first optical | between display | lens | EFL- |
| embodiment | element and lens group | unit and lens group | group | all |
| 0D | 9 | 0.9 | 20.2 | 19.6 |
| −4D | 7.2 | 0.9 | | 18.2 |
| −6d | 7.2 | 0.1 | | 18.2 |

where d2 = 1.8 mm, 0D-FOV: 47.5°, −6D-FOV: 44°, ΔFOV = 2.5°, D3 = 9.4 mm, and an eyebox size is 10.3 mm*6.5 mm.

| Third | Distance D2 | Distance D1 | EFL- | |
|---|---|---|---|---|
| embodi- | between first optical | between display | lens | EFL- |
| ment | element and lens group | unit and lens group | group | all |
| 0D | 7.4 | 2.5 | 22.53 | 19.758 |
| −2D | 6.6 | 2.5 | | 19.4 |
| −6d | 6.6 | 0.15 | | |

where d2 = 0.6 mm, 0D-FOV: 49.5°, −6D-FOV: 43.9°, ΔFOV = 5.6°, D3 = 10.7 mm, and an eyebox size is 12.5 mm*8.8 mm.

| | Distance D2 | Distance D1 | EFL- | |
|---|---|---|---|---|
| Fourth | between first optical | between display | lens | EFL- |
| embodiment | element and lens group | unit and lens group | group | all |
| 0D | 11.2 | 0.6 | 15.8 | 20.8 |
| −5d | 7.9 | 0.6 | | \ |
| −6d | 7.9 | 0.1 | | 17.7 |

where d2 = 3.4 mm, 0D-FOV: 45.5°, −6D--FOV: 43.1°, ΔFOV = 1.2°, D3 = 9.3 mm, and an eyebox size is 14.2 mm*6.2 mm.

| Fifth | Distance D2 | Distance D1 | EFL- | |
|---|---|---|---|---|
| embodi- | between first optical | between display | lens | EFL- |
| ment | element and lens group | unit and lens group | group | all |
| 0D | 9.5 | 1.5 | 21.818\ | 20.8 |
| −3d | 9.5 | 0.1 | | 20.8 |
| −6d | 7.7 | 0.1 | | 19.6 |

where d2 = 1.8 mm, 0D-FOV: 44.9°, −6D--FOV: 40.9°, ΔFOV = 4°, D3 = 9.6 mm, and an eyebox size is 11.3 mm*7 mm.

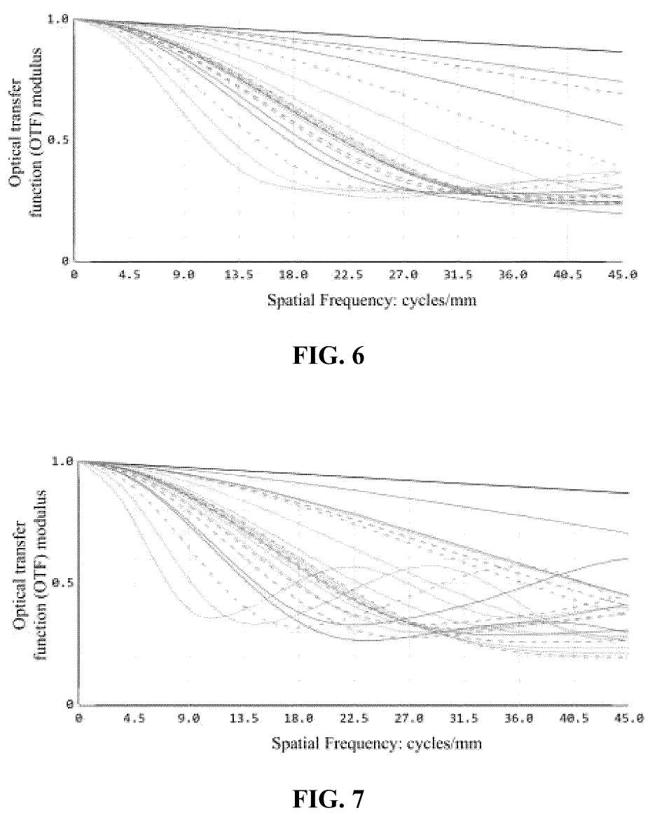

For example, reference can be made to FIG. 6 and FIG. 7. FIG. 6 is a MTF chart of an edge of an eyebox of an augmented reality display device according to an embodiment, and FIG. 7 is a MTF chart of an edge of an eyebox of an augmented reality display device according to another embodiment.

The diopter adjustment method for the augmented reality display device and the augmented reality display device provided in the present application are described in detail above. The principles and embodiments of the present application are described herein with specific examples, and the descriptions of the above embodiments are only for helping the understanding of the method according to the present application and the core idea thereof. It should be noted that for those skilled in the art, several improvements and modifications may be made to the present application without departing from the principle of the present application, and these improvements and modifications also fall within the protection scope of the claims of the present application.

1. A diopter adjustment method for an augmented reality display device, wherein
the augmented reality display device comprises a display unit, a lens group and a light guide assembly, the lens group is arranged on an output light path of the display unit, and light from the display unit is transmitted through the lens group, incident on the light guide assembly, and propagated to an eyebox area through the light guide assembly; and
the method comprises the following steps:
controlling the display unit and the lens group to move along an optical axis to change a diopter of the augmented reality display device between a first diopter value and a second diopter value, wherein a relative position between the display unit and the lens group remains unchanged; and
controlling the display unit to move along the optical axis to change the diopter of the augmented reality display device between the second diopter value and a third diopter value, wherein a position of the lens group remains unchanged, and the second diopter value is a value between the first diopter value and the third diopter value.

2. The diopter adjustment method for the augmented reality display device according to claim 1, wherein the step of controlling the display unit and the lens group to move along the optical axis to change the diopter of the augmented reality display device between the first diopter value and the second diopter value comprises:
controlling the display unit and the lens group to move towards the light guide assembly along the optical axis to change the diopter of the augmented reality display device towards the second diopter value; and
controlling the display unit and the lens group to move away from the light guide assembly along the optical axis to change the diopter of the augmented reality display device towards the first diopter value.

3. The diopter adjustment method for the augmented reality display device according to claim 1, wherein the step of controlling the display unit to move along the optical axis to change the diopter of the augmented reality display device between the second diopter value and the third diopter value comprises:
controlling the display unit to move towards the lens group along the optical axis to change the diopter of the augmented reality display device towards the third diopter value; and
controlling the display unit to move away from the lens group along the optical axis to change the diopter of the augmented reality display device towards the second diopter value.

4. The diopter adjustment method for the augmented reality display device according to claim 1, wherein the following conditions are satisfied:
d2 ranges from 0.5 mm to 3.5 mm, and d1 ranges from 0.1 mm to 2 mm, wherein
d2 represents a movement distance of the display unit and the lens group along the optical axis when the diopter of the augmented reality display device is changed between the first diopter value and the second diopter value, and d1 represents a movement distance of the display unit along the optical axis when the diopter of the augmented reality display device is changed between the second diopter value and the third diopter value.

5. An augmented reality display device, comprising a display unit, a lens group, a light guide assembly and an adjustment assembly, wherein
the lens group is disposed on an output light path of the display unit, the lens group is configured to transmit light from the display unit and direct the light to be incident on the light guide assembly, and the light guide assembly is configured to transmit the light from the display unit to an eyebox area; and
the adjustment assembly is connected to the display unit and the lens group, and is configured to independently control the display unit and the lens group to move along an optical axis to perform the diopter adjustment method for the augmented reality display device according to claim 1.

6. The augmented reality display device according to claim 5, wherein
the light guide assembly comprises a first optical element and a second optical element;
the lens group is configured to transmit the light from the display unit and direct the light to be incident on the first optical element, and the first optical element is configured to reflect light from the lens group to the second optical element and transmit light from the second optical element;
the second optical element is configured to reflect light from the first optical element back to the first optical element, and a reflecting surface of the second optical element is a curved surface; and
the following conditions are satisfied:
a distance D1 between the display unit and the lens group ranges from 0.1 mm to 2.5 mm, a distance D2 between the lens group and the first optical element ranges from 7 mm to 11.5 mm, and a distance D3 between the first optical element and the second optical element ranges from 6.5 mm to 11 mm.

7. The augmented reality display device according to claim 5, wherein a field-of-view of the augmented reality display device ranges from 35° to 50°.

8. The augmented reality display device according to claim 7, wherein a range of a variation of the field-of-view of the augmented reality display device satisfies ΔFOV<6°, wherein ΔFOV represents the variation of the field-of-view.

9. The augmented reality display device according to claim 5, wherein
when the diopter of the augmented reality display device is changed between the first diopter value and the second diopter value, a combined focal length of the lens group and the light guide assembly varies between 22 mm and 17 mm; and
when the diopter of the augmented reality display device is changed between the second diopter value and the third diopter value, the combined focal length of the lens group and the light guide assembly remains unchanged.

10. The augmented reality display device according to claim 5, wherein an exit pupil distance of the augmented reality display device is greater than 12 mm, and an exit pupil size of the augmented reality display device is 10*6 mm or above.

11. An augmented reality display device, comprising a display unit, a lens group, a light guide assembly and an adjustment assembly, wherein
the lens group is disposed on an output light path of the display unit, the lens group is configured to transmit light from the display unit and direct the light to be incident on the light guide assembly, and the light guide assembly is configured to transmit the light from the display unit to an eyebox area; and
the adjustment assembly is connected to the display unit and the lens group, and is configured to independently control the display unit and the lens group to move along an optical axis to perform the diopter adjustment method for the augmented reality display device according to claim 2.

12. The augmented reality display device according to claim 11, wherein
the light guide assembly comprises a first optical element and a second optical element;
the lens group is configured to transmit the light from the display unit and direct the light to be incident on the first optical element, and the first optical element is configured to reflect light from the lens group to the second optical element and transmit light from the second optical element;
the second optical element is configured to reflect light from the first optical element back to the first optical element, and a reflecting surface of the second optical element is a curved surface; and
the following conditions are satisfied:
a distance D1 between the display unit and the lens group ranges from 0.1 mm to 2.5 mm, a distance D2 between the lens group and the first optical element ranges from 7 mm to 11.5 mm, and a distance D3 between the first optical element and the second optical element ranges from 6.5 mm to 11 mm.

13. An augmented reality display device, comprising a display unit, a lens group, a light guide assembly and an adjustment assembly, wherein
the lens group is disposed on an output light path of the display unit, the lens group is configured to transmit light from the display unit and direct the light to be incident on the light guide assembly, and the light guide assembly is configured to transmit the light from the display unit to an eyebox area; and
the adjustment assembly is connected to the display unit and the lens group, and is configured to independently control the display unit and the lens group to move along an optical axis to perform the diopter adjustment method for the augmented reality display device according to claim 3.

14. The augmented reality display device according to claim 13, wherein
the light guide assembly comprises a first optical element and a second optical element;
the lens group is configured to transmit the light from the display unit and direct the light to be incident on the first optical element, and the first optical element is configured to reflect light from the lens group to the second optical element and transmit light from the second optical element;
the second optical element is configured to reflect light from the first optical element back to the first optical element, and a reflecting surface of the second optical element is a curved surface; and
the following conditions are satisfied:
a distance D1 between the display unit and the lens group ranges from 0.1 mm to 2.5 mm, a distance D2 between the lens group and the first optical element ranges from 7 mm to 11.5 mm, and a distance D3 between the first optical element and the second optical element ranges from 6.5 mm to 11 mm.

15. An augmented reality display device, comprising a display unit, a lens group, a light guide assembly and an adjustment assembly, wherein
the lens group is disposed on an output light path of the display unit, the lens group is configured to transmit light from the display unit and direct the light to be incident on the light guide assembly, and the light guide assembly is configured to transmit the light from the display unit to an eyebox area; and
the adjustment assembly is connected to the display unit and the lens group, and is configured to independently control the display unit and the lens group to move along an optical axis to perform the diopter adjustment method for the augmented reality display device according to claim 4.

16. The augmented reality display device according to claim 15, wherein
the light guide assembly comprises a first optical element and a second optical element;
the lens group is configured to transmit the light from the display unit and direct the light to be incident on the first optical element, and the first optical element is configured to reflect light from the lens group to the second optical element and transmit light from the second optical element;
the second optical element is configured to reflect light from the first optical element back to the first optical element, and a reflecting surface of the second optical element is a curved surface; and
the following conditions are satisfied:
a distance D1 between the display unit and the lens group ranges from 0.1 mm to 2.5 mm, a distance D2 between the lens group and the first optical element ranges from 7 mm to 11.5 mm, and a distance D3 between the first optical element and the second optical element ranges from 6.5 mm to 11 mm.

17. The augmented reality display device according to claim 15, wherein a field-of-view of the augmented reality display device ranges from 35° to 50°.

18. The augmented reality display device according to claim 17, wherein a range of a variation of the field-of-view of the augmented reality display device satisfies ΔFOV<6°, wherein ΔFOV represents the variation of the field-of-view.

19. The augmented reality display device according to claim 15, wherein
when the diopter of the augmented reality display device is changed between the first diopter value and the second diopter value, a combined focal length of the lens group and the light guide assembly varies between 22 mm and 17 mm; and
when the diopter of the augmented reality display device is changed between the second diopter value and the third diopter value, the combined focal length of the lens group and the light guide assembly remains unchanged.
